(19) United States
(12) Patent Application Publication
(10) Pub. No.: US 2005/0184695 A1
(43) Pub. Date: Aug. 25, 2005

(54) Garage door that has enhanced preventive safety measures and equipment to accommodate precise and timely maintenance

(75) Inventor: Duke Chen, Taipei (TW)

Correspondence Address: BACON & THOMAS, PLLC, 625 SLATERS LANE, FOURTH FLOOR, ALEXANDRIA, VA, 22314, US

(73) Assignee: EQUUS Inc., Taipei (TW)

(21) Appl. No.: 10/780,755

(22) Filed: Feb. 19, 2004

(51) Int. Cl. H02P 3/00; H02P 1/04

(52) U.S. Cl. 318/480; 318/16

(57) ABSTRACT

The invention provides a garage door that can have enhanced preventive safety measures and equipment to accommodate precise and timely maintenance. It is mainly to add into the garage door control mechanism a transceiver that uses electromagnetic waves in the form of laser, infrared, or supersonic wave as distance-measuring and transmission medium, which is directly reflected to the transceiver through a moving roller. In this way, the distance between the moving roller and the garage door can be measured. The roller speed can be pre-determined, so it equals to the garage door speed. Besides, the preset roller speed can be compared to the actual roller speed. This comparison ratio is used as a precise reference to determine whether the closing garage door hits an obstacle or carry out preventive safety maintenance. Thus, accidents can be prevented when the garage door is closing. The invention provides enhanced preventive safety measures and equipment to accommodate precise and timely maintenance.

### FIELD OF THE INVENTION

The invention is related to a garage door that has enhanced preventive safety measures and equipment to accommodate precise and timely maintenance. More specifically, it possesses a sound preventive safety measure and is able to provide a reference to implement precise and timely maintenance. Therefore, the invention prevents accidents and any mechanical safety concerns due to improper maintenance.

### BACKGROUND OF THE INVENTION

Please refer to FIG. 1. The traditional garage door mostly has track (4) on both sides of the door (1), so the garage door (1) can move along the track (4) through rollers. In the center of garage ceiling, there is a rail (30) and a door control mechanism (2) located at the end. On the rail (30), there is a roller (32) attached to a hinge arm (31). The hinge arm (31) is attached to the garage door (1) at its other end. Through this configuration, when the garage door control mechanism (2) receives user's command, it automatically opens or closes the door.

First of all, to prevent injury accidents when a closing door (1) hits a person, usually a safety device that comprises a single-beam transmitter unit and a receiver unit (5) is installed near the ground at both sides of the door. An electric wire (6) along the periphery of the door (1) connects the safety device and the door control mechanism (2). Thus, when an obstacle appears on the path of a closing door and blocks the beam, the door control mechanism (2) responds immediately to reverse or stop the garage door (1) and assures the safety of vehicles or humans.

Secondly, the maintenance on garage door usually is carried out according to an estimate of hours of usage or a pre-determined schedule. However, this maintenance plan does not assure a timely service is provided when it is needed according to mechanical condition. Therefore, either an estimate of hours of usage or a pre-determined schedule fails to work as a criterion to determine whether a required maintenance is due. Consequently, this type of garage door (1) has safety concerns in use.

Although the above-mentioned garage door has a safety device for closing door and a reference to set up maintenance schedule, after careful examination several shortcomings can be found as follows:

1. Because the safety device for traditional garage door uses a single horizontal beam, it only detects the obstacle on a horizontal line in certain height level. Thus, when it fails to detect the obstacle on a horizontal line in other height level, a detection error is made and an accident could happen. This design can not assure the safety for an entry door and poses a potential risk. Besides, it lacks flexibility and applicability.

2. Secondly, the estimated or pre-determined maintenance schedule fails to work properly to provide timely service. This type of garage door has safety concerns in use.

Further, the safety device and the door control mechanism are linked through an exposed wire, so it causes inconvenience for installation. In addition, an exposed wire is susceptible to damage. Its maintenance is difficult. It is hard to find out interruption of signal transmission. This aggravates the difficulty in safety control. On the other hand, exposed wiring affects aesthetics and tidiness for the garage.

With consideration on the entire existing shortcoming and disadvantages for the safety device for traditional garage door, the inventor applies his expertise to invent “a garage door that has enhanced preventive safety measures and equipment to accommodate precise and timely maintenance”. The invention has value in safety, progressiveness and applicability. It is expected to overcome the above shortcomings and improve quality, convenience and safety.

### SUMMARY OF THE INVENTION

The main objective for the present invention is to provide a garage door that has enhanced preventive safety measures and equipment to accommodate precise and timely maintenance. It is expected to overcome the shortcomings for the safety device of the traditional garage door. It will improve the safety measure and implementation of a maintenance schedule. Therefore, it prevents accidents in the garage closing process and mechanical safety problems due to improper maintenance schedule. It will enhance safety measures and provide timely maintenance for garage door equipment.

Another objective for the present invention is to achieve no exposed wiring and aesthetics by providing a garage door that has enhanced preventive safety measures and equipment to accommodate precise and timely maintenance.

To accomplish the above objectives, the invention mainly adds into the garage door control mechanism a transceiver composed of a transmitter and a receiver that use electromagnetic waves in the form of laser, infrared, or supersonic wave as distance-measuring and transmission medium. Thus, the transmitted wave is reflected to the transceiver through a roller. In this way, the distance between the moving roller and the garage door can be measured. The roller speed can be preset in each unit distance, the setting also controls the garage door speed in each unit distance. Then, the ratio of preset roller speed to the actual roller speed can be used as a reference to determine whether a closing garage door hits an obstacle and to plan on maintenance schedule. Thus, accidents can be prevented when the garage door is closing. The invention provides enhanced preventive safety measures and equipment to accommodate precise and timely maintenance.

The objective, features and benefits for the invention are described in the following. It is hoped that the examiners will get thorough understanding through the explanation below.

### BRIEF DESCRIPTION OF THE DRAWINGS

FIG. 1 is a three-dimensional illustration for the garage door.

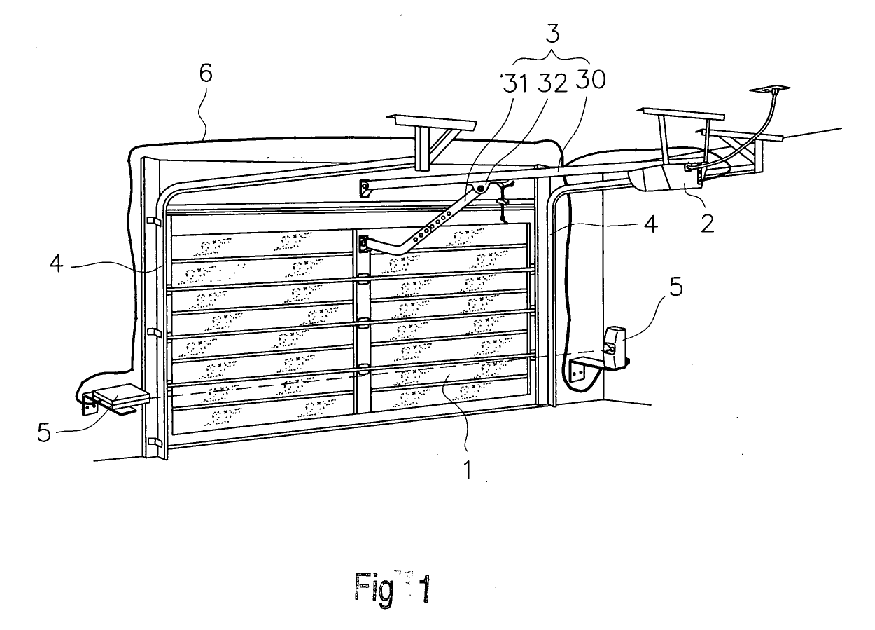

FIG. 2 is a three-dimensional illustration for a preferable example for the invention.

FIG. 3 is a two-dimensional illustration for the action for the invention.

FIG. 4 is a two-dimensional illustration for the transmission and reception of an electromagnetic wave in a preferable example for the invention.

### DETAILED DESCRIPTION OF THE INVENTION

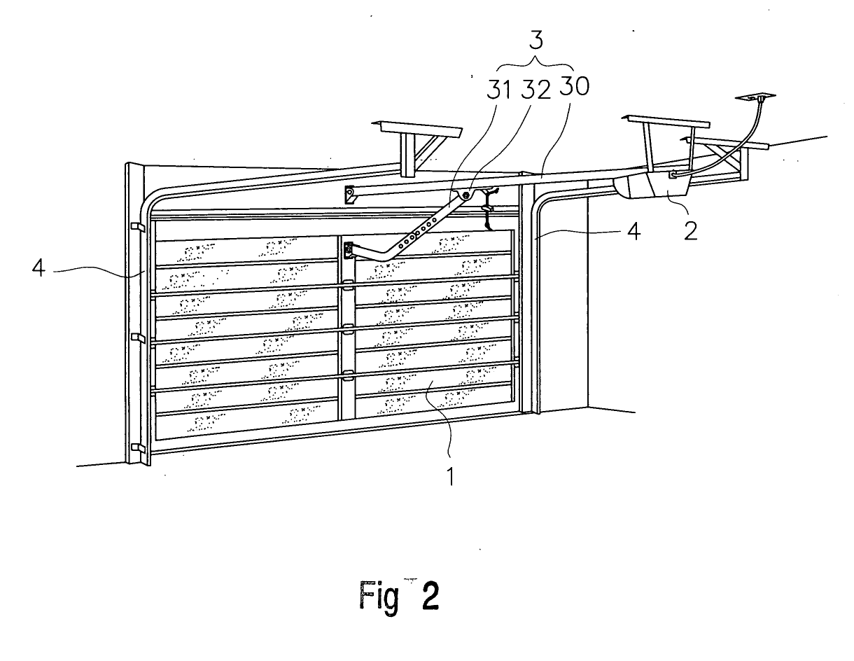

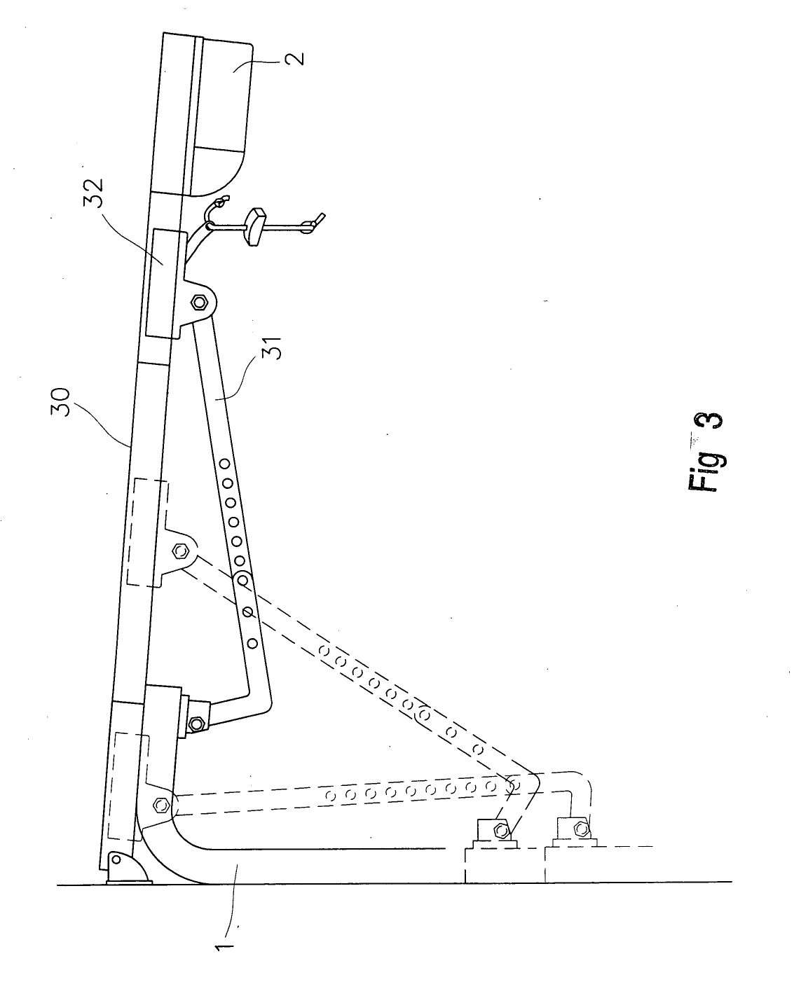

Please refer to FIG. 2 and FIG. 3, which are three-dimensional illustration for the overall appearance and two-dimensional illustration for the action for the invention. Immediately after receiving control signal, the garage door (1) executes closing or opening command and preset door sliding speed. It has a door control mechanism (2), which is linked to the garage door (1) through a moving mechanism (3) composed of a rail (30), a hinge arm (31) and a roller (32) and a door track (4) on both sides. Through this configuration, when the garage door control mechanism (2) receives user's command, it automatically opens or closes the door (1), which slides at a preset speed in each unit distance.

The above-mentioned roller (32) moves in the rail (30), inside which there is a chain driven by a motor so it drives the roller (32) to move and achieves the control of door (1) opening and closing. The motor is installed in the door control mechanism (2). Its speed (round/second) is controlled by the preset roller (32) speed (meter/second) in a synchronized mode. When the garage door (1) hits an obstacle, the preset speed for roller (32) is different from the actual speed for roller (32). The motor will reverse to drive the roller (32) through the chain to back to the door control mechanism (2), so the door will be in an opening state.

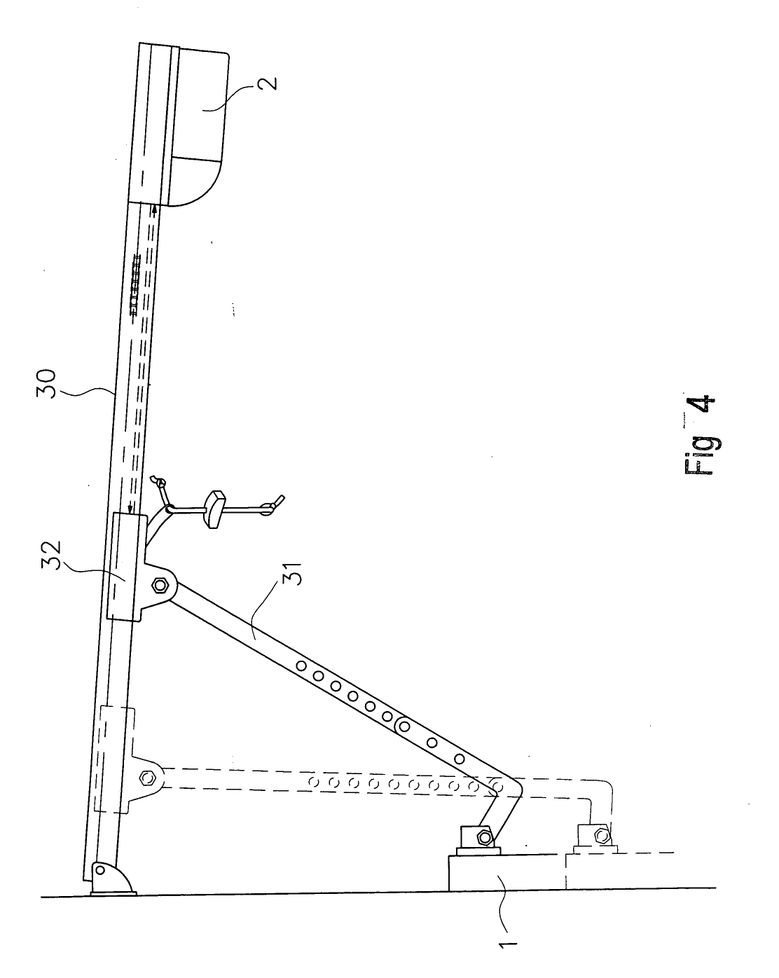

Please refer to FIG. 4. The main features for the invention are:

Adding into the garage door control mechanism (2) a transceiver that uses electromagnetic waves in the form of laser, infrared, or supersonic wave as distance-measuring and transmission medium (not shown in Figure); the transmitted wave from the transmitter in the control mechanism (2) reflected to the receiver through the roller (32). In this way, the distance between the moving roller (32) on the rail (30) and the garage door control mechanism (2) can be measured. The roller (32) speed equals to the preset roller (32) speed in each unit distance. When the preset speed is different from the actual speed, it allows the roller (32) to back to the door control mechanism (2) and leaves the door (1) in opening state. The distance measurement mode and the ratio of preset roller speed to the actual roller speed can be used as a safety measure and references to plan on a timely maintenance schedule. It also automatically controls the closing and opening for the garage door (1) and the speed in each unit distance.

With this design, when the garage door is closing, the beam transmitted from the transmitter in the door control mechanism (2) is directly reflected through the roller (32) to the receiver. The distance between the roller (32) and the garage door control mechanism (32) can be measured. The actual roller (32) speed in each unit distance depends on the preset speed. The preset speed for roller (32) in each unit distance is compared to the actual speed to derive a ratio, which then is used as a reference to determine whether the closing garage door (1) hits an obstacle and to plan on a timely maintenance schedule. If the two speeds do not match, the door (1) is stopped and back to opening state or maintenance is required. The design allows control over door opening, closing and speed in each unit distance. The comparison between preset speed and actual speed is used to determine whether the closing door (1) hits an obstacle and plan on a timely maintenance schedule. The invention provides enhanced preventive safety measures and equipment to accommodate precise and timely maintenance.

From the above description, it is known that with an added transceiver inside the door control mechanism using electromagnetic wave from a transmitter through the roller to the receiver for distance measurement, the ratio of the preset roller speed and the actual roller speed provides a safety measure and a reference to plan on a precise and timely maintenance schedule. It is not only different from the sensor equipment in the periphery of a traditional garage that usually causes accident by failing to detect an obstacle, but also has no exposed and complicated wiring. The invention provides an aesthetic feeling and prevents the drawback of failing to notice transmission signal interruption. Besides, the timely equipment maintenance is made possible.

In general, the invention provides a garage door that can have enhanced preventive safety measures and equipment to accommodate precise and timely maintenance. Its practical value in application is shown in safety and applicability. It is considered as a breakthrough in this field of industry and meets the requirements for innovation type of patent. The application for patent is thus submitted.

1. A garage door that can have enhanced preventive safety measures and equipment to accommodate precise and timely maintenance is composed of a garage door, a control mechanism on top, a moving mechanism between the door and the control mechanism and a door track; the moving mechanism further comprises a rail, a hinge arm, a roller etc. with features as follows:
adding into the garage door control mechanism a transceiver that uses electromagnetic waves in the form of laser, infrared, or supersonic wave as distance-measuring and transmission medium, which is directly reflected to the transceiver through a moving roller; in this way, the distance between the moving roller and the garage door can be measured; the roller speed can be pre-determined, so it equals to the garage door speed; besides, the preset roller speed can be compared to the actual roller speed; this comparison ratio is used as a precise reference to determine whether the closing garage door hits an obstacle or plan on preventive safety maintenance; thus, accidents can be prevented when the garage door is closing; the problems due to improper maintenance are also avoided; and the invention provides enhanced preventive safety measures and equipment to accommodate precise and timely maintenance.
